(19) United States
(12) Patent Application Publication
(10) Pub. No.: US 2009/0106081 A1
(43) Pub. Date: Apr. 23, 2009

(54) INTERNET ADVERTISING USING PRODUCT CONVERSION DATA

(75) Inventors: David Anthony Burgess, Menlo Park, CA (US); Kishore Ananda Papineni, Carmel, NY (US); Jagdish Chand, Fremont, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/876,550

(22) Filed: Oct. 22, 2007

(51) Int. Cl. G06Q 20/00

(52) U.S. Cl. 705/10; 705/14

(57) ABSTRACT

Methods and apparatus for determining the effectiveness of web pages are described. For each of a plurality of conversion points corresponding to a particular product or service, a plurality of paths leading to the conversion point are determined. Each of the plurality of paths leading to the conversion point includes a plurality of web pages connected by links. Each web page is characterized with respect to each of selected ones of the plurality of conversion points which may be reached from the web page via at least one of the paths. Characterizing each web page and/or its content includes determining a measure of effectiveness which represents a likelihood that viewing of the web page will lead to one or more of the selected conversion points.

### BACKGROUND OF THE INVENTION

1. Field of the Invention

The present invention relates to methods and computer program products relating to Internet advertising. More specifically, the present invention relates to methods and computer program products for improving the effectiveness of Internet advertising by analyzing and characterizing various types of pages, such as, for example, web pages, in terms of their potential for leading users or viewers of the web pages toward one or more conversion points.

2. Background of the Invention

An advertisement is typically a one-way communication, often paid, through some form of medium that provides information relating to a sponsor's products and/or services. Generally, there are four relevant parties involved in the advertising process. The sponsor is the party that wishes to present the information and usually pays for the advertisement. The publisher designs and creates the advertisement and usually has a depository of ads. The facilitator provides the medium, such as, for example, ad servers or ad campaigns, for publishing the advertisement and often charges the sponsor a fee for the use of the medium. And the audience is the party to whom the sponsor wishes to present the information. Sometimes, the sponsor and the publisher or the facilitator may be the same party.

The types of information found in the advertisement may include, for example, publicity, public relations, product placement, sponsorship, underwriting, sales promotion, etc. The types of media for publishing or delivering advertisements may vary widely. Television, radio, movies, magazines, newspapers, billboards, the Internet, building walls, shopping carts, and clothing are but some of the many types of advertising media. In fact, advertisements may be placed anywhere an audience has access.

It is desirable to all parties involved that advertising is conducted effectively, so that the right messages reach the right audience at the right time. Advertising effectiveness may be measured based on, for example, cost per lead, cost per click of an ad on a web page, or cost per acquisition. From a sponsor's point of view, it is desirable that the advertisement is as effective as possible for the amount of money spent. From a publisher's and a facilitator's point of view, the more effective the advertisements, the more likely that the sponsors are willing to place advertisements with the publisher and the facilitator, and the higher fee the publisher and the facilitator may charge the sponsors. From an audience's point of view, the right messages at the right time are more appealing than the wrong messages at the wrong time.

Accordingly, what are needed are systems and methods to improve the effectiveness of advertising on the Internet.

### SUMMARY OF THE INVENTION

Broadly speaking, the present invention relates to systems and methods for managing the display of items on pages.

In one embodiment, methods and apparatus are provided for determining the effectiveness of web pages is provided, in which: for each of a plurality of conversion points corresponding to a particular product or service, determining a plurality of paths leading to the conversion point, wherein each of the plurality of paths leading to the conversion point includes a plurality of web pages connected by links; and characterizing each web page with respect to each of selected ones of the plurality of conversion points which may be reached from the web page via at least one of the paths, wherein characterizing each web page includes determining a measure of effectiveness which represents a likelihood that viewing of the web page, including the content of the web page and/or the ad(s) displayed on the web page, will lead to one or more of the selected conversion points.

The links connecting the web pages include static as well as dynamic links, such as clickable links that are a part of the content of the web pages or ads displayed on the web pages.

In another embodiment, methods and apparatus are provided for presenting advertisements on web pages, wherein links among the web pages define a plurality of paths leading to a plurality of conversion points, and each conversion point corresponding to a particular product or service, is provided. Advertisements are presented on the web pages, each advertisement having been selected for presentation on a particular one of the web pages with reference to a measure of effectiveness associated with particular web page, the measure of effectiveness representing a likelihood that viewing of the particular web page will lead to one or more of the conversion points.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings in which like reference numerals refer to similar elements, and in which:

FIG. 1 (prior art) illustrates an example of a sales funnel.

FIG. 2 illustrates an example of a portion of a network of web pages forming multiple paths leading to multiple conversion points.

FIG. 3 illustrates an example of multiple paths formed by the web pages leading to one conversion point.

FIGS. 4A and 4B illustrate two different paths respectively formed by the web pages leading to the same conversion point.

FIG. 5 illustrates one web page that is on multiple paths leading to multiple conversion points.

FIG. 6 illustrates an example of multiple paths, each formed by multiple web pages, leading to a conversion point, where each web page includes multiple product advertisements.

FIG. 7 illustrates a method of constructing one or more paths, each formed by one or more web pages, leading to one or more conversion points.

FIG. 8 illustrates a method of characterizing a web page with respect to each of the conversion points that the web page is on at least one path leading to the conversion point.

FIG. 9 illustrates a method of analyzing web pages based on their characteristics with respect to the corresponding conversion points in order to determine the appropriate advertisements for the web pages.

FIG. 10 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

In one or more embodiments, web session data that represent users' browsing among and interaction with the web pages are collected. These session data are then used to determine all the web pages users have visited before arriving at a conversion point, which may be a purchase of a product or service, a potential opportunity for a business, a booking, a reservation, etc. These web pages in effect form one or more paths leading to the conversion point.

For each web page that is on one or more paths leading to one or more conversion points, a measure of effectiveness is determined which represents the likelihood that viewing of the web page will lead users to one or more of the conversion points. This measure of effectiveness may be based, for example, on the probability that users will traverse one or more paths to one or more conversion points. Such probabilities may, in turn, be based on session data relating to the “click-through rate” from one page to another in a path, e.g., of the viewers of a particular page, the number that moved down a path to the next page.

In addition, the web pages may be categorized based on their respective positions relative to one or more conversion points (e.g., the number of “hops” on the path to a conversion point, or using the analogy of a “sales funnel” as described below, etc.), and/or purposes (e.g., product awareness, product comparison, product review, product sale, etc.). Each web page is thus characterized in terms of these and other data. Based on the data characterizing each web page, a variety of actions or decisions may follow such as, for example, the selection and presentation of appropriate advertisements for the web page, modification or elimination of the web page, determination of how much to charge for advertising on the web page, etc. Various embodiments are described below in greater detail.

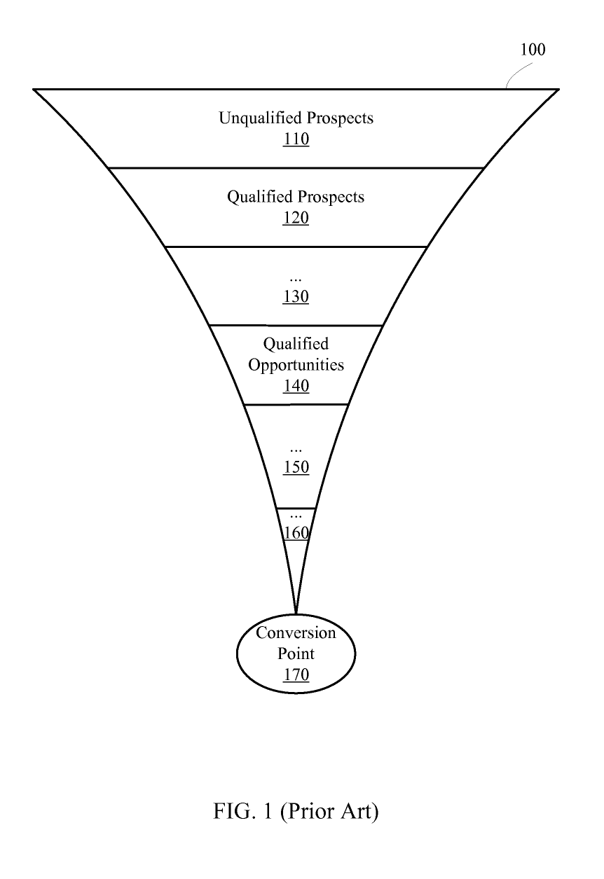

The term “sales funnel” is often used to describe the sales process. FIG. 1 (prior art) illustrates an example of a sales funnel. The metaphor of a funnel, i.e., wide at the top and narrow at the bottom, is used to describe what happens during the typical sales process. At the top of the funnel 100 are “unqualified prospects” 110. The unqualified prospects 110 are unqualified opportunities which may include any party that may potentially be interested in the products and/or services provided by a particular business. The unqualified prospects 110 may be thought of as the “catch-all” level, and usually, the business has no contact with the unqualified prospects 110, and thus has not yet determined whether the unqualified prospects 110 may move down the funnel 100 toward a sale or conversion point 170. Nevertheless, these people may be good candidates for brand advertising.

Below the “unqualified prospects” 110 in the funnel 100 are the “qualified prospects” 120, which are parties selected by the business to further pursue the opportunities. The business may focus its time and energy on the qualified prospects 120 in the hopes of leading the qualified prospects 120 further down the funnel 100 toward the conversion point 170. The selection is made based on some criteria. An unqualified prospect 110 usually becomes a qualified prospect 120 after the business determines that there is a likelihood that the unqualified prospect 110 may eventually arrive at the conversion point 170. Thus, a good qualified prospect 120 may be a party that needs the products and/or services provided by the business within a relatively short time-frame and has the budget to purchase these products and/or services.

After some interactions with the qualified prospects 120, e.g., communication, solution presentation and development, etc., and perhaps going through one or more additional levels 130, some of the qualified prospects 120 may develop into qualified opportunities 140 at some point further down the funnel 100. And with further work, e.g., negotiation, purchase agreement, delivery, payment, etc., and perhaps going through one or more levels 150, 160, eventually some of the parties arrive at the conversion point 170.

The process is wide at the top and narrow at the bottom, i.e., funnel shaped, because parties drop off at each level along the sales process due to various reasons. Not all unqualified prospects 110 are selected by the business and become qualified prospects 120, not all qualified prospects 120 develop into qualified opportunities 140, and so on. For example, some parties may decide to find alternative products and/or services from other businesses or decide not to purchase, while other parties may not have the necessary budget. The term “conversion rate” is sometimes used to indicate the effectiveness or performance of a sales funnel, which may be expressed as the ratio of the parties arriving at the conversion point to the parties entering the funnel.

The concept of the sales funnel may be applied to businesses conducted over the Internet. However, with Internet business transactions, there may not be so much direct or personal interactions between the businesses and their customers. Instead, the businesses provide information about their products and/or services on the Internet, often displaying the information on various web pages, and the customers obtain information about various products and/or services from the Internet and make their decisions accordingly. In this case, the hosts or owners of the websites where the information is published are the publishers. The businesses that advertise their products and/or services at various websites are the sponsors. And the viewers of the web pages are the audiences.

The word “advertisement” is used here broadly, and is not limited only to items such as banners and/or advertisements displayed on the web pages. An advertisement may include any information published on the web pages in any form or manner that relates to the sponsors and their products and/or services. For example, in addition to banners and ads, an advertisement may include specification or detailed description of a product, a product review, a comparison between multiple products, etc. Such information may be published as a part of the main content of the web pages, e.g., a web page that provides a comparison of the various features of different brands or models of automobiles, or may be a part of the auxiliary or secondary content of the web pages, e.g., a web page that displays a person's email inbox but also displays ads at the top, bottom, or sides of the page.

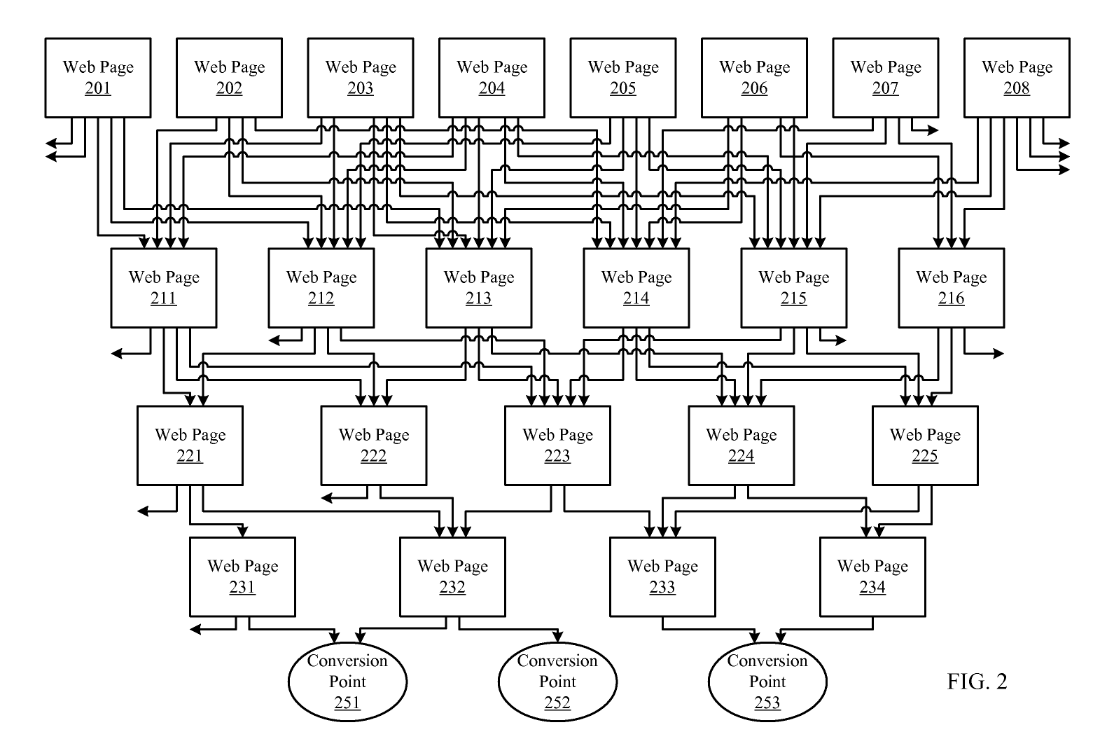

FIG. 2 illustrates an example of a portion of a network of web pages forming multiple paths leading to multiple conversion points. Although FIG. 2 uses web pages as a specific example, the same concept applies to networks formed by various other types of pages, such as pages displayed on smart phones or personal digital assistants (PDA). To simplify discussion, FIG. 2 only shows a small portion of the network of web pages leading to three conversion points 251, 252, 253. In practice, there may be, hundreds, thousands, or hundreds of thousands of web pages, interlinked together and forming many paths that lead to many different conversion points for many different products.

There are many different types of conversion points. For example, a conversion point may be where a buyer purchases a product and/or service or makes a reservation or booking through a web page at a website. A conversion point may also be where a viewer, by viewing information about certain products and/or services on one or more web pages, eventually visits the seller of the products and/or services in person, perhaps for the purpose of obtaining additional information about the products and/or services or to make a purchase. A conversion point may be where a viewer requests additional information from a business about certain products and/or services shown on some web pages, and as a result becomes a qualified opportunity for the business. In fact, a conversion point may be any event, occurrence, or action on the part of a web page viewer or a buyer, i.e., a member of the audience that the host of the website, i.e., the publisher, and the business, i.e., the sponsor, agreed upon as the conversion point. The publisher and the sponsor may agree that the actual purchases of two different products are two different conversion points, or they may agree that any purchase of any product is the same conversion point. They may agree that only an actual purchase of a product or service qualifies as a conversion point, or they may agree that other audience actions, such as requesting product information or referring products to friends, also qualify as conversion points.

Different values may be associated with different types of conversion points. For example, in one scenario, a web page viewer, i.e., a member of the audience, may eventually arrive at a conversion point for purchasing a product. In this case, the viewer becomes a buyer or a customer of the business selling the product. In another scenario, a web page viewer may arrive at a conversion point for requesting additional information of a product. In this case, the viewer perhaps becomes a qualified opportunity for the business selling the product. From the business', i.e., the sponsor's, point of view, the first conversion point, i.e., the viewer's actual purchasing of the product, may be more valuable than the second conversion point, i.e., the viewer merely becoming a qualified opportunity that may or may not result in any actual purchase.

The web pages shown in FIG. 2 are interconnected, such that one page may lead to one or more other web pages, and so on. Viewers may traverse from one web page to another by, for example, clicking on a hyper link embedded in the content of the first web page, or even on an advertisement or sponsored link on the first web page. Thus, the term “lead” describes the operation of any of a variety of mechanisms by which a viewer of one web page may arrive at another web page. One web page may lead its viewers to one or more different web pages, e.g., because often there are many hyper links embedded in one web page. In the example shown in FIG. 2, web page 201 may lead its viewers to five different web pages: web pages 211, 212, and 213 and two other web pages not shown in FIG. 2. Web page 202 may lead its viewers to four different web pages: web pages 211, 212, 213, and 214. Conversely, one or more different web pages may all lead their viewers to the same one web page. For example, web pages 221, 222, and 223 may all lead their viewers to web page 232. Similarly, one or more web pages may lead to the same conversion point, and one web page may lead to one or more different conversion points. For example, web pages 233 and 234 both lead to conversion point 253. Web page 232 may lead to two different conversion points 251 and 252.

Which web page is linked to which other web pages or conversion points typically depends on the content of the web page as well as the hyper links embedded in the web page. As explained above, a viewer of a first web page may be directed, e.g., led, to a second web page by clicking on a hyper link embedded anywhere in the first web page. The process may be repeated, and as a result, a viewer may traverse a path, from one web page to another and another, toward a conversion point. The web page at the very beginning of the path is the starting point, and the conversion point at the end of the path is the end point. In other words, the path, formed by one or more web pages, leads a viewer toward the conversion point.

Of course, the viewer may or may not eventually arrive at the conversion point. That is, not every viewer traveling down a path leading to a conversion point will eventually arrive at the conversion point. Of the many viewers who may traverse the same path, some may actually arrive at the conversion point, but others may drop off the path at various stages and never arrive at the conversion point. Various types of data, such as a click-through rate, may be used to determine how many viewers drop off the path and at what stage. The concept of click-through rate and its usage will be explained in more detail below.

Generally speaking, for web pages positioned near the beginning of the paths, there is a greater possibility that viewers may branch out and be directed to different paths. In the example shown in FIG. 2, viewers of web page 203 may be led down five different paths, each path leading to a different web page, i.e., web pages 211, 212, 213, 214, and 215. On the other hand, for web pages positioned near the end of the paths, i.e., closer to the conversion points, there is a lesser possibility that viewers may branch out and be directed to different paths. For example, viewers of web page 223 may be led down two different paths, each path leading to a different web page, i.e., web pages 232 and 233. In addition, viewers may drop off the paths, i.e., stop traversing further down the paths, at various stages. Thus, with respect to each conversion point, the further away a web page is from the conversion point, the less likely that a viewer of the web page will traverse down a path and eventually arrive at the conversion point. Conversely, the closer a web page is to the conversion point, the more likely that a viewer of the web page will traverse down a path and eventually arrive at the conversion point. Consequently, with respect to each conversion point, it is possible to calculate the probability for each web page on a path leading to the conversion point that a viewer of the web page will be led down the path and eventually arrive at the conversion point.

Web pages may then be divided into categories based on the calculated probabilities with respect to the conversion points. The probability values may be divided into ranges, and each category may represent a particular range of probability values. A web page with probability values that fall within a certain range would belong to the corresponding category representing that range for the respective conversion points.

In addition or alternatively, web pages may be divided into categories based on their relative positions with respect to the conversion points. For example, web pages 201, 202, 203, 204, 205, 206, 207, and 208 are the farthest, i.e., four steps away from conversion points 251, 252, 253, and may be grouped into one category for those conversion points. Web pages 211, 212, 213, 214, 215, and 216 are one step closer, i.e., three steps away from the conversion points 251, 252, 253, and may be grouped into another category for those conversion points. Web pages 221, 222, 223, 224, and 225 are two steps away from the conversion points 251, 252, 253, and may be grouped into a third category for those conversion points. Finally, web pages 231, 232, 233, and 234 are one step away from the conversion points 251, 252, 253, and may be grouped into a fourth category for those conversion points.

Furthermore, web pages may be divided into categories based on other characteristics including their respective content, formats, purposes, etc. For examples, if web pages are categorized based on their purposes, then one category may include web pages whose purpose is to provide product awareness, another category may include web pages whose purpose is to provide product comparison, a third category may include web pages whose purpose is to provide product reviews, and so on.

As may be seen from the example shown in FIG. 2, there are different types of relationships between the web pages and the conversion points. It may be clearer to discuss some of these relationships between web pages and conversion points individually.

First, from a particular conversion point's view, one or more paths, each path formed by one or more web pages, may lead viewers of the web pages to the same conversion point. In other words, viewers may start from different starting points, i.e., web pages, traverse along different paths, and eventually arrive at the same conversion point. Furthermore, it is not necessary for viewers to always start at the very beginning of a path. Viewers may start with a web page that is located anywhere along a path and traverse the path from thereon toward the conversion point. To each individual viewer, the web page that he or she starts with may be considered his or her own starting point.

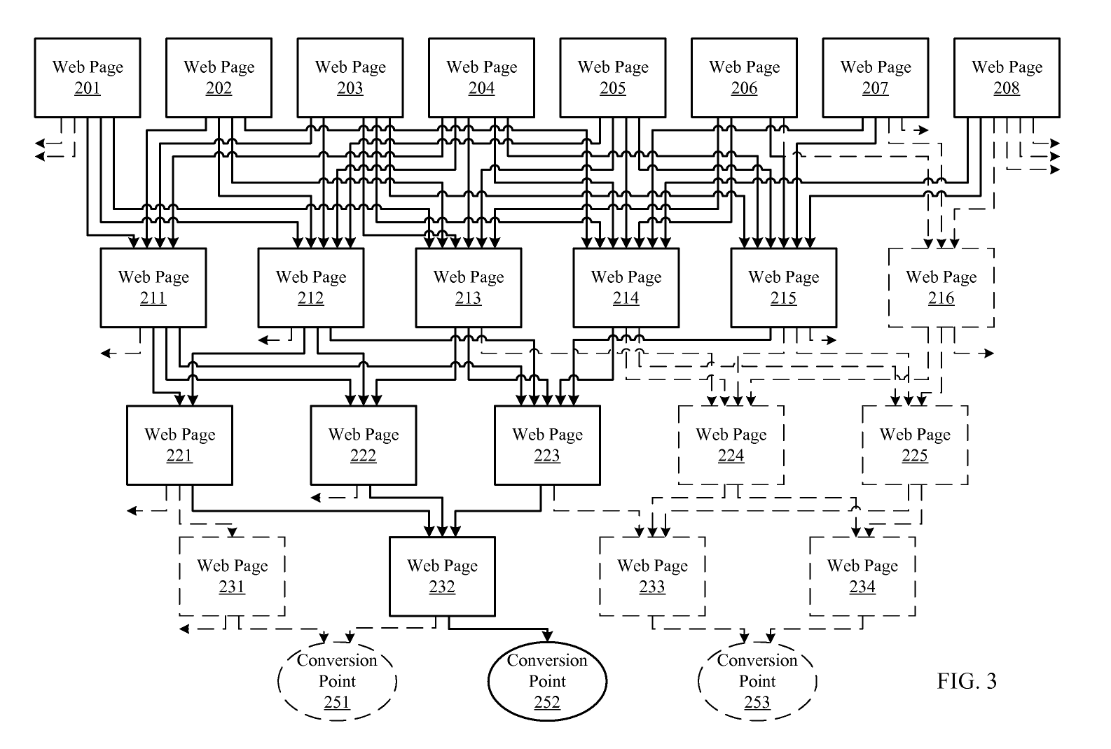

FIG. 3 illustrates an example of multiple paths formed by the web pages leading to one conversion point. Although FIG. 3 focuses on one particular conversion point 252, the same concept applies to all other conversion points.

As shown in FIG. 3, there are several paths leading to conversion point 252, and each path is formed by multiple web pages. Specifically, web page 201 may lead a viewer to web page 211, which in turn may lead to web page 221, which in turn may lead to web page 232, which in turn may lead to conversion point 252. In this case, web pages 201, 211, 221, and 232 forms one path leading to conversion point 252, and web page 201 may be considered the starting point of this path. Alternatively, web page 201 may lead a viewer to web page 213, which in turn may lead to web page 223, which in turn may lead to web page 232, which in turn may lead to conversion point 252. Thus, web pages 201, 213, 223, and 232 form another path leading to conversion point 252, and web page 201 may again be considered the starting point of this second path. Note that web pages 201 and 232 are on both paths leading to conversion point 252. In other words, it is possible for a particular web page to be a part of multiple paths leading to the same conversion point. It is also possible for a particular web page to lead its viewers down different paths, and yet toward the same conversion point.

A third path in FIG. 3 leading to conversion point 252 is formed by web pages 207, 215, 223, and 232. In this case, web page 207 may be considered the starting point for this third path. In other words, different starting points, i.e., web pages, may lead toward the same conversion point, as both web pages 201 and 207 may lead their respective viewers toward conversion point 252.

With respect to conversion point 252, all the paths, each formed by multiple web pages, leading toward it form a “funnel” for conversion point 252. Analogous in some ways to the sample sales funnel shown in FIG. 1, the funnel for conversion point 252 is also wider at the top, i.e., more users at the top of the funnel near the starting points, and narrower at the bottom, i.e., fewer users reach the conversion point 252.

The web pages near the starting points, i.e., near the top of the funnel, usually have smaller probabilities of leading viewers to conversion point 252 than the web pages near conversion point 252, i.e., near the bottom of the funnel. For example, web page 203 probably has a smaller probability of leading viewers to conversion point 252 than web page 213, which in turn probably has a smaller probability of leading viewers to conversion point 252 than web page 223, and so on. Generally, the further away from the conversion point, the less likely that a web page will lead viewers to the conversion point. Web pages further away from the conversion point, e.g., web pages 201, 202, 203, 204, 205, 206, 207, and 208, may branch out to more different paths than web pages closer to the conversion point, e.g., web pages 221, 222, 223, 224, and 225. In addition, some of the viewers may drop off the paths at one stage or another for various reasons, such as having lost interest in the particular product or wishing to find alternative choices.

Using these characteristics, web pages that are on the paths leading to a conversion point may be categorized based on their respective positions relevant to the conversion point, and/or their respective probabilities to lead viewers to the conversion point. For example, in terms of web page positions relevant to the conversion point, web pages that are approximately the same distance away from the conversion point may be categorized together. Thus, in FIG. 3, web pages 201, 202, 203, 204, 205, 206, 207, and 208 are farthest away, i.e., about four levels or steps away, from conversion point 252, and may be categorized together into one category. Web pages 211, 212, 213, 214, and 215 are about the same distance, i.e., about three levels or steps, away from conversion point 252, and may be categorized together into another category. Web pages 221, 222, 223, 224, and 225 are about two levels or steps away from conversion point 252, and may be categorized together into a third category. Finally, web page 232 is closest to conversion point 252, i.e., only one level or step away from conversion point 252, and may be categorized into a fourth category.

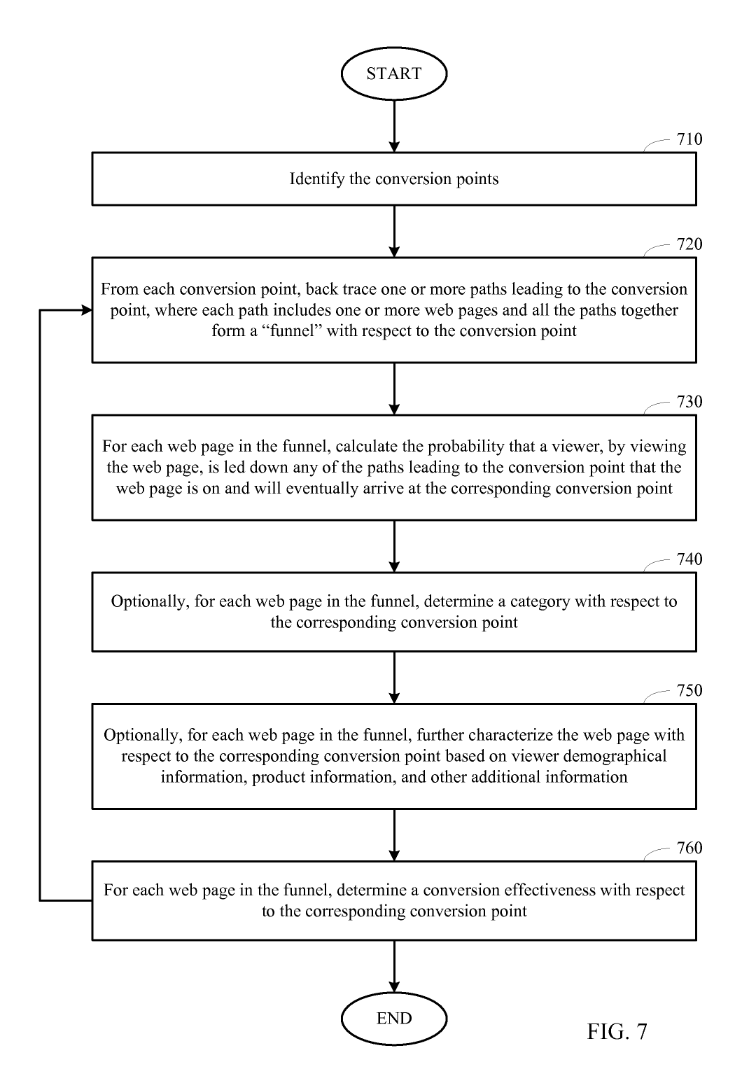

In terms of categorizing web pages based on their respective probabilities to lead viewers to the conversion point, for example, web pages having similar ranges of probabilities may be categorized together. In FIG. 3, since web pages 201, 202, 203, 204, 205, 206, 207, and 208 are farthest away from conversion point 252, each of these web pages probably has a relatively small probability of leading viewers down one of the paths eventually to conversion point 252. Web pages 211, 212, 213, 214, 215, and 216, being one level or step closer to conversion point 252, probably have relatively greater probability of leading viewers down one of the paths eventually to conversion point 252 than web pages 201, 202, 203, 204, 205, 206, 207, and 208. Similarly, web pages 221, 222, 223 probably have relatively greater probability of leading viewers down one of the paths eventually to conversion point 252 than web pages 211, 212, 213, 214, 215, and 216. And web page 232, being the closest to conversion point 252, probably has the greatest probability among all the web pages in the funnel associated with conversion point 252 of leading viewers to conversion point 252. Although the actual probability values may vary for the individual web pages, depending on the actual method used to calculate the probability values, the probability values of the web pages usually decrease as the web pages are farther away from the conversion point. The probability values of the web pages may be divided into ranges, and web pages having probability values within the same range may be categorized together. One way to calculate the probability values for the web pages and/or determine their positions on the paths is to use the historical user session data. This process will be explained in more detail below in FIG. 7.

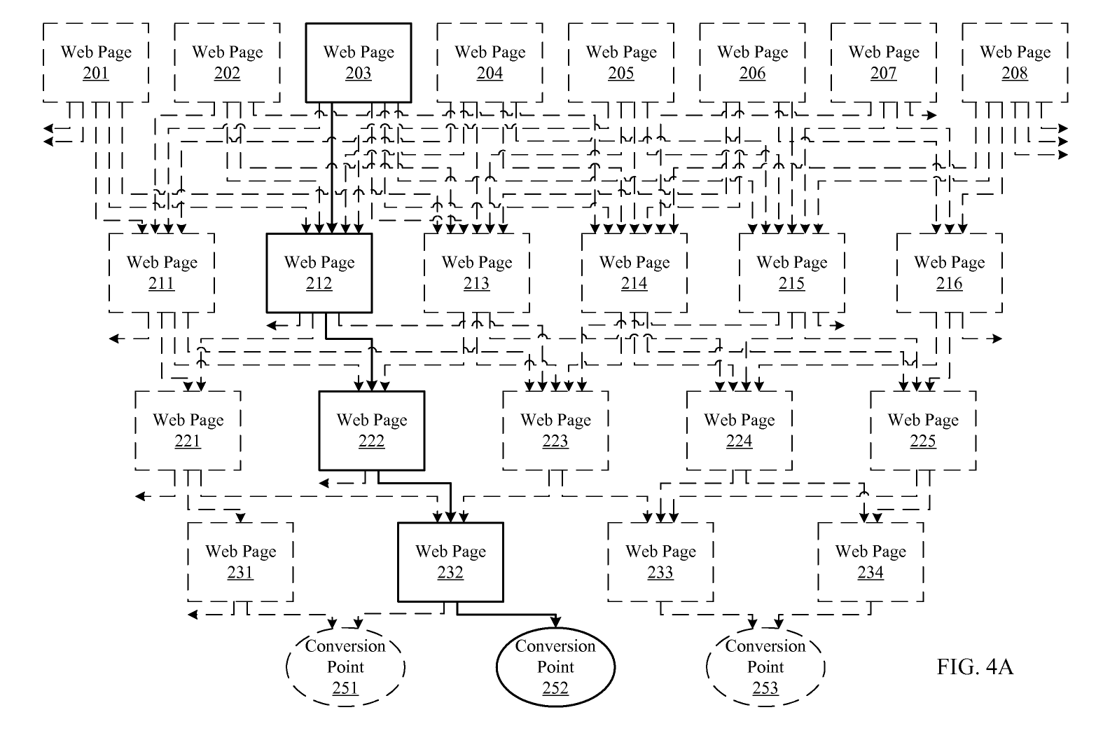

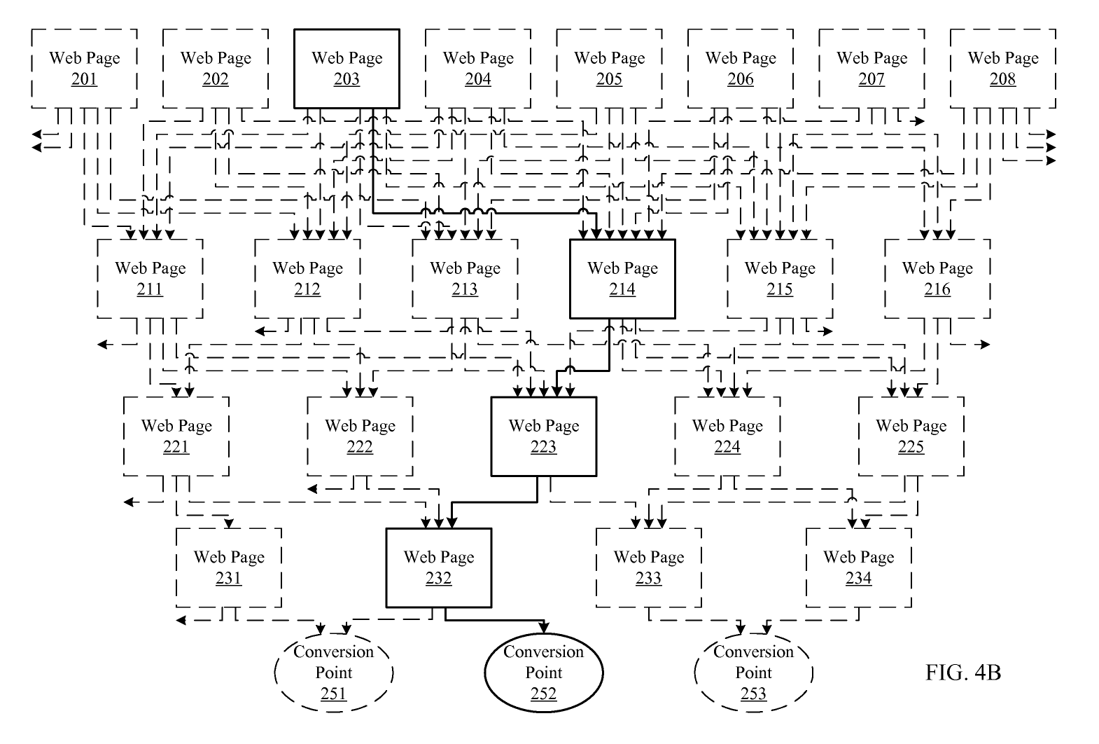

As shown in FIG. 3, the same starting point, i.e., a web page, may lead viewers down multiple, different paths, and yet arrive at the same conversion point. To provide a clearer visual representation, FIGS. 4A and 4B illustrate two different paths respectively formed by the web pages leading to the same conversion point, and the two different paths both start from the same starting point, i.e., web page 203. In the path shown in FIG. 4A, web page 203 leads to web page 212, which leads to web page 222, which leads to web page 232, which finally leads to conversion point 252. In the path shown in FIG. 4B, web page 203 leads to web page 214, which leads to web page 223, which leads to web page 232, which finally leads to conversion point 252.

In these two examples, for web page 203 that is on multiple paths leading to the same conversion point 252, there may be multiple probability values associated with web page 203 with respect to conversion point 252. First, there may be a first probability value associated with web page 203 with respect to conversion point 252, indicating the probability that viewers of web page 203 may be led down the path shown in FIG. 4A eventually to conversion point 252. Next, there may be a second probability value associated with web page 203 with respect to conversion point 252, indicating the probability that viewers of web page 203 may be led down the path shown in FIG. 4B eventually to conversion point 252. Finally, there may be an aggregated probability value associated with web page 203 with respect to conversion point 252, indicating the probability that viewers of web page 203 may be led down any one of the paths web page 203 is on to conversion point 252. In one example, the aggregated probability value associated with web page 203 with respect to conversion point 252 may be the sum of all the probability values associated with web page 203 for all the individual paths leading to conversion point 252 that web page 203 is on. However, other formulas may be used to calculate the aggregated probability value, depending on the actual implementations of the system. The same concept applies to web pages located anywhere along the paths leading to a conversion point.

There are various ways that viewers of a particular web page may be led down a particular path to a conversion point. Using the path shown in FIG. 4A as an example, a viewer of web page 203 may be interested in an advertisement published on web page 203 and wishes to find out more about the product described in the advertisement. The viewer clicks on the hyper link embedded in the advertisement on web page 203, and is then led to web page 212, which provides additional detailed information, such as the specification, about the product in question. The viewer may like the product very much. Thus, the viewer may click a hyper link on web page 212 in order to be led to web page 222 so that he or she may purchase the product from an online seller. From web page 222, the viewer may click a button to add the product to the viewer's shopping cart. Then, the viewer may click another button or link on web page 222 to complete the transaction. This may lead the viewer to web page 232, where the viewer may provide payment information and submit the purchase order. By completing the actual purchase, the viewer has arrived at conversion point 252.

Not only may a web page lead viewers down different paths to the same conversion point, a web page may also lead viewers down different paths to different conversion points. For example, a web page at an online shopping site, such as Yahoo!® shopping, may divide the merchandise into categories. One category may be “Clothing & Accessories.” Another category may be “Computers.” Other categories may include “Home and Garden,” “Jewelry & Watches,” “Sports & Outdoors,” and so on. One viewer of the web page may be interested in computer products, while another viewer may be interested in sports related products. Thus, the first viewer may click on the hyper link associated with the “Computers” category and be led down one path, and the second viewer may click on the hyper link associated with the “Sports & Outdoors” category and be led down another path. If both viewers do not drop off their respective paths at some future point, then the two viewers may eventually arrive at two conversion points for the two different types of products. One conversion point may be the purchase of a notebook computer, while another conversion point may be the purchase of a pair of athletic shoes.

In another example, two viewers of the web page may be interested in the same product. However, one viewer may be ready to purchase the product, while another viewer may still be considering his or her decision and wishes to obtain additional information about the product. Thus, the two viewers may branch out down two different paths. The first viewer may eventually arrive at a conversion point for purchasing the product, while the second viewer may eventually arrive at a conversion point for obtaining additional information about the product from the seller, i.e., the sponsor, of the product. In this example, the two conversion points are associated with the same product, but the actions taken by the viewers are different.

In yet another example, a web page may display information about a particular type of product, e.g., automobiles. Two viewers, one interested in purchasing a car while another interested in subscribing to automobile magazines, may both view the same web page, seeking information on automobiles. Again, the two viewers may be led down to two different paths, one toward purchasing a car and another toward subscribing an automobile magazine.

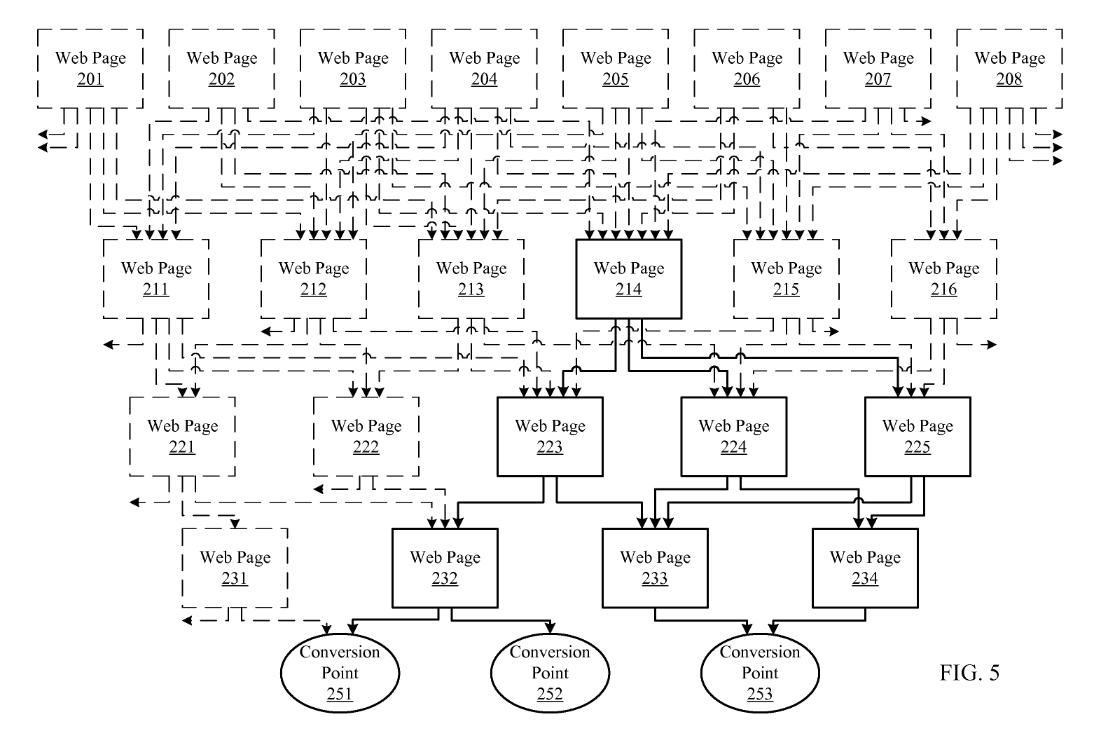

FIG. 5 illustrates one web page that is on multiple paths leading to multiple conversion points. In the example shown in FIG. 5, web page 214 may branch out into three different paths, leading viewers of web page 214 to web pages 223, 224, and 225 respectively. Each of web pages 223, 224, and 225 may be related to a different product and may further branch out to more paths. For example, a first viewer of web page 214 who is interested in a particular product may be led to web page 223. Another viewer, i.e., the second viewer, of web page 214 who is interested in a different product may be led to web page 224.

From web page 223, the first viewer may be led to web pages 232 or 233. Assuming the first viewer chooses to view web page 232, from there, the first viewer may eventually arrive at conversion points 251 or 252. The second viewer, on the other hand, may be led to web page 234 from web page 224, and eventually arrives at conversion point 253. Thus, viewers of web page 214 may traverse different paths to eventually arrive at three different conversion points: conversion points 251, 252, and 253. In other words, web page 214 is on multiple paths leading to conversion points 251, 252, and 253. This factor may be taken into consideration when categorizing web page 214 and/or calculating probabilities that web page 214 may lead viewers to conversion points.

When categorizing web page 214 based on its positions relative to the multiple conversion points, it is possible that web page 214 may be closer to one conversion point than another. Thus, with respect to the first conversion point, web page 214 may belong to one category, while with respect to the second conversion point, web page 214 may belong to another category.

Similarly, there may be a different probability value with respect to each of the three conversion points 251, 252, and 253 that viewers of web page 214 may be led down one of the paths toward these conversion points respectively.

Consequently, for web pages that are on multiple paths leading to multiple conversion points, such as web page 214, optionally, an aggregated probability value may be calculated which indicates the probability that viewers of web page 214 may be led to any of the conversion points 251, 252, 253, i.e., any of the conversion points that web page 214 is on the paths leading to. One way to calculate this aggregated probability value is to sum all the probability values associated with web page 214 with respect to conversion points 251, 252, and 253. Other formulas may be used depending on the actual implementations of the system, and/or the relatedness of the conversion points as well as values or profits associated with the conversion points.

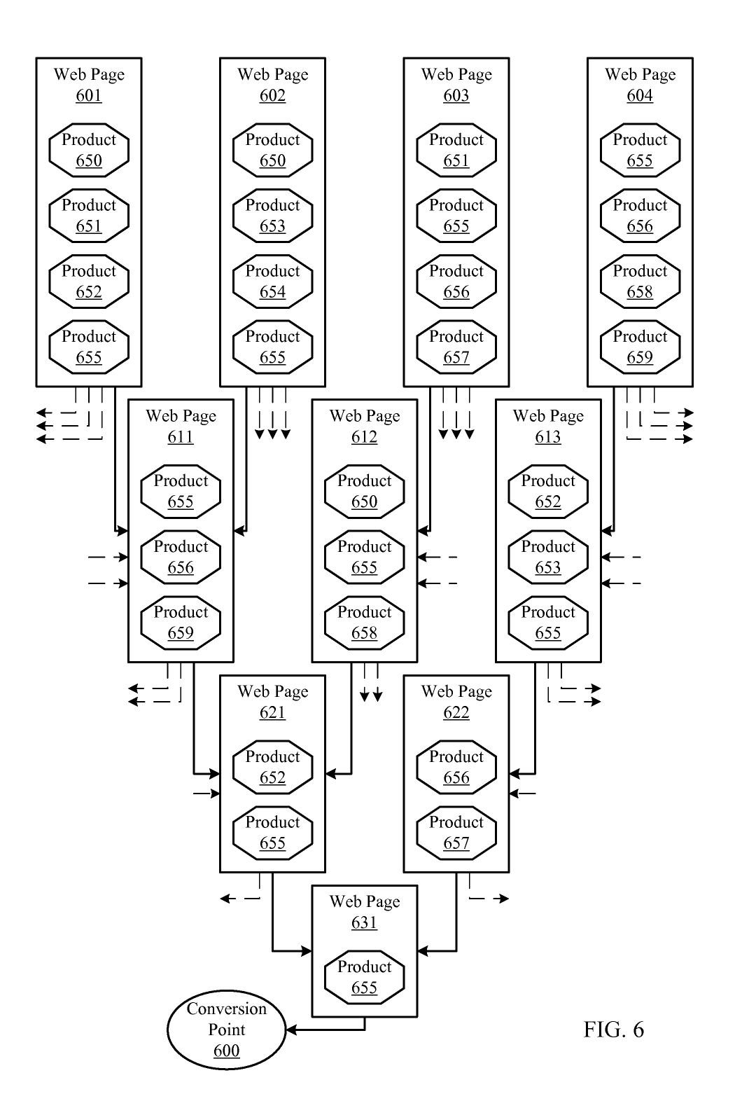

Having described some of the different relationships between web pages and conversion points, as shown in FIGS. 2-5, it may be helpful to focus on one conversion point and the web pages forming the paths leading to it, i.e., the funnel for the conversion point. FIG. 6 illustrates an example of multiple paths, each formed by multiple web pages, leading to a conversion point, where each web page includes multiple product advertisements. To simplify the discussion, only a few paths and a small number of web pages are shown. In practice, however, there may be many paths, formed by a great number of web pages, leading to a conversion point.

In FIG. 6, web pages 601, 602, 603, and 604 each contains product information for four different products. Specifically, web page 601 contains information for products 650, 651, 652, and 655. Web page 602 contains information for products 650, 653, 654, and 655. Web page 603 contains information for products 651, 655, 656, and 657. And web page 604 contains information for products 655, 656, 658, and 659. The information displayed on the web pages may differ in format, design, category, etc. But regardless of how the product information is presented on the web pages, a hyper link or equivalent mechanism is associated with each product.

Some products may be included in multiple web pages. For example, both web pages 601 and 602 contain information relating to product 650. However, it may be the same information or may be different information, perhaps emphasizing different aspects or advantages of the product.

Viewers of these web pages may be led down different paths depending on which product they are interested in and what type of information regarding the products they seek. For example, a viewer, viewing web page 601, may be interested in product 655 and, by clicking on the hyper links associated with product 655, be led to web page 611, which contains additional and/or more detailed information on product 655. Similarly, another viewer, viewing web page 602, may also be interested in product 655 and be led to web page 611. A third viewer, viewing web page 603, may be interested in product 655, but may be led to web page 612 instead. Finally, a fourth viewer, viewing web page 604, may be interested in product 655 and may be led to web page 613.

Next, from web pages 611 and 612, viewers who are interested in product 655 may be led to web page 621. From web page 613, viewers who are interested in product 655 may be led to web page 622.

From web pages 621 and 622, viewers who are interested in product 655 may be led to web page 631 and eventually arrive at conversion point 600. Thus, the product associated with conversion point 600 in this example is product 655. Of course, other products included in the web pages will have their own respective conversion points.

Since a particular conversion point is often associated with a particular product or service, and more specifically, a particular type of action or occurrence with respect to the particular product or service, when characterizing the web pages forming the paths leading to the conversion point in terms of their positions with respect to the conversion point, their categories, their probabilities of leading viewers to the conversion point, etc., the characterizations are often associated with the product or service associated with the conversion point. In other words, the characterizations are often specific to the particular product or service associated with the conversion point.

Furthermore, when characterizing the web pages, e.g., in terms of their probability, category, product, advertisement effectiveness, etc., as described above, the demographic information of the viewers may also be considered as an additional factor. This concept will be described in more detail below.

FIG. 7 is a method of constructing one or more paths, each formed by one or more web pages, leading to one or more conversion points. At 710, all the conversion points are identified. As explained before, there are various types of conversion points. Consequently, there are various ways to identify a conversion point. For example, a conversion point may be an actual purchase of a product. In this case, a final order submission via a web page or a payment for the product may be used to identify the conversion point. The buyer goes through a checkout process, which may include steps for confirming the merchandise in the shopping cart, creating an account, providing a shipping address, delivery instruction, and payment information, etc., and finally the buyer arrives at a point for submitting the order. Once the buyer takes the action that causes the order to be submitted, such as clicking the “submit” button on a web page, the buyer has arrived at the conversion point. Thus, the submission of the order may be used to identify the conversion point. Alternatively, the charge of the buyer's credit card or bank account for the purchase may be used to identify the conversion point.

In another example, a conversion point may be to obtain a qualified opportunity for a business. If a potential customer is interested in a particular product, he or she may fill out a form online to request additional information from the business. As the potential customer submits the form through a web page, he or she has arrived at a conversion point. Thus, the submission of the form may be used to identify the conversion point. Other types of conversion points may be similarly identified by various consumer activities, either online or offline.

Once the conversion points are identified, at 720, from each conversion point, back trace all the paths leading to the conversion point, where each path includes one or more web pages, and all the paths form a “funnel” with respect to the conversion point. Using FIG. 6 as an example, for conversion point 600, there are four different paths leading to conversion point 600. The first path is formed by web pages 601, 611, 621, and 631. The second path is formed by web pages 602, 611, 621, and 631. The third path is formed by web pages 603, 612, 621, and 631. The fourth path is formed by web pages 604, 613, 622, and 631. Although in FIG. 6, each path is formed by four web pages, in practice, a path may be formed by any number of web pages, and multiple paths leading to the same conversion point are often formed by different number of web pages.

To determine the first path from conversion point 600, one would start at conversion point 600, which has already been identified, and back trace the web pages one by one, i.e., from conversion point back tracing to web page 631, from web page 631 back tracing to web page 621, from web page 621 back tracing to web page 611, and finally from web page 611 back tracing to web page 601. The back tracing is repeated until one reaches the starting point of the path, which, in this example, is web page 601. In other words, the starting point of a path is the web page from where one cannot trace back any further.

There are different ways to back trace web pages. For example, often, a user who views the web pages is led from one page to another by clicking on a hyper link embedded in the first web page. In this case, the session data associated with the web pages may contain information relating to the user's actions, which may include information such as which hyper link is clicked by the user, which web page contains the hyper link, which web page the hyper link leads to, user demographic information, etc. The session data may be collected and analyzed to help determine what actions on the part of the user may cause the user to be led from one particular web page to another web page.

To be more specific, assume a person, user A, upon viewing web page 601, is interested in product 655 described on web page 601. User A then clicks on the hyper link associated with product 655, which leads user A to web page 611. This action on the part of user A may be recorded using session data associated with web page 611 and stored in some database. When user A is led from web page 611 to web page 621, again following a hyper link on information relating to product 655, relevant information may again be recorded and associated with web page 621. Such information may be recorded every time a user is led from one web page to another, and all these session data may be collected and stored for analysis and processing.

Similarly, assume another person, user B, upon viewing web page 602, is interested in certain information on product 655. By clicking on a link to obtain additional information on product 655, user B is also led to web page 611. The action on the part of user B may also be recorded using session data associated with web page 611 and stored somewhere for further analysis.

Thus, to back trace from web page 611, session data associated with web page 611 may be selected and analyzed. From some data values, it may be determined that users may be led to web page 611 from web page 601. From other data values, also associated with web page 611, it may be determined that users may alternatively be led to web page 611 from web page 602. In this case, from web page 611, one may back trace to web pages 601 and 602, each defining a part of a different path.

In addition to the use of session data as described above and according to some embodiments, paths leading to conversion points may be determined by examining existing links between web pages without reference to user session data. That is, many existing links between web pages are relatively static and can therefore be identified and indexed by automated processes which “crawl” these links to identify, among other things, the manner in which they are connected. Thus, the present invention is not necessarily limited to determining the paths in a funnel from user session data.

The back tracing process may be repeated for a particular conversion point as necessary to identify each of the paths leading to the conversion point. The paths may be represented by a “funnel” with respect to the conversion point. This process may be implemented as a computer software program. In some implementations, a recursive algorithm may be used to systematically identify each possible path leading to the conversion point by identifying the web pages forming the paths. A tree-like data structure may be used to represent the web pages and the conversion points. Alternatively, the web pages may be represented using the data structure described in U.S. Pat. No. 6,873,996 to Jagdish Chand.

Of course, it is not always necessary to identify each and every path leading to a particular conversion point. Depending on the specific implementations, it is possible to identify only some of the paths leading to a conversion point. In this case, only web pages or the ads on the pages forming the identified paths will be characterized and analyzed.

Once at least some of the paths, and thus the web pages, leading to at least some of the conversion points are identified, at 730, for each web page in the funnel of a conversion point, calculate a probability that a user, by viewing the web page, is led down any of the paths in the funnel and will eventually arrive at the conversion point. Recall that generally, the further away a web page is from a conversion point, the less likely a user of the web page will be led down a path to the conversion point, and vice versa. Using FIG. 6 again as an example, web pages 601, 602, 603, and 604 generally have smaller probabilities than web pages 611, 612, and 613 to lead users to conversion point 600. Web pages 611, 612, and 613 in turn usually have smaller probabilities than web pages 621 and 622 to lead users to conversion point 600. And web pages 621 and 622 generally have smaller probabilities than web page 631 to lead users to conversion point 600.

There are different ways to calculate the probability values for each web page in the funnel with respect to the corresponding conversion point. One way is to use the click-through rate. A click-through rate for a web page is obtained by dividing the number of users who click on a hyper link on the web page by the number of times the hyper link is delivered with the web page, i.e., the number of impressions or the number of times the web page, along with the hyper link, is displayed. For example, if a hyper link embedded in a web page is delivered to various users 100 times, but only 5 users click on the link, then the click-through rate for this particular link embedded in this web page is 5%. At the same time, it may be determined that 95 out of the 100 users, i.e., 95%, drop off the path at this stage.

Assume that on average, for every 100 users who view web page 601, users click on a particular link relating to product 655 and are led to web page 611. Thus, from web page 601 to web 611, the click-through rate is 15 users out of 100 users, i.e., 15%. Out of the 15 users arrived at web page 611, on average 5 are led to web page 621 by clicking on a link relating to product 655 on web page 611. Thus, from web page 611 to web page 621, the click-through rate is 5 users out of 15 users, i.e., approximately 33.33%. Out of the 5 users of web page 621, on average 2 are led to web page 631. Thus, from web page 621 to web page 631, the click-through rate is 2 users out of 5 users, i.e., 40%. Out of the 2 users arrived at web page 631, on average only one user is finally led to conversion point 600. Thus, from web page 631 to conversion point 600, the click-through rate is one user out of every 2 users, i.e., 50%.

Using these click-through rates for the web pages, it may be calculated that the probability that a user of web page 601 is led down a path eventually arriving at conversion point 600 is 1%, since on average, out of every 100 users who have viewed web page 601, only one user eventually arrives at conversion point 600. Similarly, the probability that a user of web page 611 is led down the path eventually arriving at conversion point 600 is approximately 6.67%, since on average, out of every 15 users who have viewed web page 611, one user eventually arrives at conversion point 600. The probability that a user of web page 621 is led down the path eventually arriving at conversion point 600 is 20%, since on average, out of every 5 users who have viewed web page 621, one user eventually arrives at conversion point 600. Finally, the probability that a user of web page 631 is led down the path eventually arriving at conversion point 600 is 50%, since on average, for every 2 users who have viewed web page 631, one user eventually arrives at conversion point 600.

The same process may be repeated as many times as necessary to calculate probability values for all the identified web pages that are part of one or more paths leading to the conversion point. The numbers used above are meant as an example to help explain a particular method of calculating the probabilities for the web pages with respect to the corresponding conversion point using the click-through rates. These numbers may not reflect real life situations or scenarios. In fact, it is very likely that in practices, the click-through rates and probabilities for the web pages may differ greatly from the numbers used above.

Click-through rate is not the only way to calculate the probabilities for the web pages with respect to the corresponding conversion point. Alternatively, for example, session data may be used to uniquely identify individual users of the web pages. These session data may be collected and processed to determine users' movements along various paths formed by the web pages. It is possible to determine the number of users traversing the paths to the corresponding conversion point and the number of users dropping off somewhere along the way. These numbers may then be used to calculate the probabilities for the web pages with respect to the corresponding conversion point. To be more specific, if it may be determined that on average, for every 100 users who have viewed web page 601, 99 of them eventually drop off the path leading to conversion point 600 and only one user arrives at conversion point 600, then the probability that users of web page 601 will be led to conversion 600 is one out of 100, i.e., 1%. Similar calculations may be applied to the other web pages.

Furthermore, if a web page is on multiple paths, either leading to the same or different conversion points, aggregated probability values may be calculated based on the individual probability values calculated with respect to each of the paths the web page is on. In the example shown in FIG. 6, each web page leads users down only one path toward conversion point 600. However, as explained before, it is also possible that a particular web page may lead its users down multiple paths and yet toward the same conversion point. One example is shown in FIG. 5, that web page 214 may lead users down 5 different paths toward conversion point 253. The first path is from web page 214 to web page 223 to web page 233 and to conversion point 253. The second path is from web page 214 to web page 224 to web page 233 and to conversion point 253. The third path is from web page 214 to web page 224 to web page 234 and to conversion point 253. The fourth path is from web page 214 to web page 225 to web page 233 and to conversion point 253. The fifth path is from web page 214 to web page 225 to web page 234 and to conversion point 253.

In this case, to calculate a probability that a user of web page 214 may eventually be led to conversion point 253, it may be necessary to consider all the possible paths that the user may traverse in order to arrive at conversion point 253. In other words, the probability value would be an aggregated probability value, taking into consideration of all the possible paths leading to conversion point 253. To be more specific, if, on average, for every 100 users of web page 214, one user eventually arrives at conversion point 253 via the first path, two users eventually arrives at conversion point 253 via the second path, no user arrives at conversion point 253 via the third path, one user eventually arrives at conversion point 253 via the fourth path, and three users eventually arrives at conversion point 253 via the fifth path, then the probability that a user of web page 214 is led down any of the path to conversion 253 may be assumed to be 7%, i.e., 7 users out of every 100 users. In other words, for each web page that is a part of the funnel with respect to a conversion point, the aggregated probability that a user, by viewing the web page, is led to the conversion point represents the probability that the user, by viewing the web page, may be led down any of the possible paths the web page is on to the conversion point.

In many instances, as in the example shown in FIG. 5, one web page may lead users to different conversion points. When characterizing such a web page's effectiveness, it may be important to take into consideration that the web page may lead users to more than one conversion point, and thus is more valuable, at least in some aspects, than those web pages that only lead users to one conversion point. This may also result in an aggregated value which may be arrived at through any of a wide variety of algorithms which refer to or take into account the probabilities associated with the various conversion points.

In addition to the probability values, optionally, at 740, for each web page in the funnel, determine a category with respect to the corresponding conversion point. The category may be established based on various criteria. For example, in one or more embodiments, the categories may be established based on the purposes of the web pages in the funnel. The purposes of the web pages may, for example, be based on the types, nature, or content of the product information displayed in the web pages. Some web pages may display general information that is aimed at product awareness. Other web pages may provide more specific information, such as providing detailed product specification, product comparison, product review, information on product availability and dealer locations, product purchase, etc. Web pages that provide similar types of product information may be grouped together into individual categories.

In other embodiments, the categories may be determined based on each web page's position on the paths leading to the conversion point, and/or based on each web page's distance from the conversion point. Web pages that are approximately equally distant from the conversion point may be grouped together, or web pages that are positioned similarly on different paths leading to the conversion point may be grouped together.

Recall that one method to construct a funnel for a conversion point is to back trace along each of the paths leading to the conversion point to determine each and every web page along these paths. Through the back tracing process, the position of each web page on the paths may be determined. This information may then be used to categorize the web pages as described above.

In other embodiments, the categories may be determined based on each web page's probability of leading users to the corresponding conversion point, as calculated in step 730. Web pages may be grouped together based on the calculated individual or aggregated probability values. For example, web pages having probability values between 1% and 10% may be grouped into one category. Web pages having probability values between 10% and 25% may be grouped into another category. Web pages having probability values between 25% and 50% may be grouped into a third category. Web pages having probability values greater than 50% may be grouped into a fourth category.

Also in addition to the probability values, optionally, at 750, the web pages may be further characterized based on user profile, including user demographic information, user behavioral interest, and user geographical location, product information, and other information.

First, with user profile, the probability values and/or categories described in steps 730 and 740 may be limited to users within a certain profile group. User demographic information may include, for example, age, gender, ethnicity, profession, education, income, interest, marital status, etc. User geographical location may indicate the locations of a user's residence, work, travel destination, etc. User behavioral interest may indicate what products, hobbies, etc. the user enjoys. Each of the characteristics of the web pages may be determined based on actions or data associated with users from a particular profile group. For example, the probabilities for the web pages may be calculated based only on user data associated with users within a certain age group, e.g., users between the ages of 20 and 40 years old, a gender group, a profession group, a geographical group, a hobby group, etc. In other words, for each web page, a probability may be calculated that represents the likelihood that a user between the ages of 20 and 40, or a female user, or a user living in the state of New York, or a user who is interested in portable electronic products, etc. may be led down any of the paths leading to the conversion point and eventually arrives at the conversion point. Of course, multiple pieces of demographic information may be combined to construct a user group. Thus, for each web page, a probability may be calculated that represents the likelihood that a female user between the ages of 20 and 40 and residing in the state of New York may be led down any of the paths leading to the conversion point and eventually arrives at the conversion point.

Similarly, the categories of the web pages may be determined further based on user profile information. For example, one category of web pages may include web pages having probability values between 1% and 10% of leading male users with a college degree or higher to a particular conversion point.

There are various ways to obtain user profile information. For example, often, in order to use the services provided by a website, such as Yahoo!® Mail or Yahoo!® Travel, a person is required to register and create a personal account with the website. Thereafter, the person becomes a registered user of the website. The user may optionally provide personal, i.e., demographic, information to the website, which is then associated with the user's account. Subsequently, every time the user logs into his or her account, the user may be identified by a unique cookie. When such a user's session data generated from the user's Internet activities are used to characterize the web pages, the user's demographic information may be retrieved and taken into consideration. Similarly, when a user buys certain product, it may be an indication that the user is interested in that type of product. Or, when a user enters his or her home or work address into his or her account, the address may be used to determine the user's geographical location.

Another type of information that may optionally be taken into consideration is the product or service involved. Often, each particular conversion point is associated with a particular product or service, such as the sale of the product or service, providing leads to the seller of the product or service with respect to the product or service, recommending the product or service, etc. Thus, the funnel associated with a conversion point may be further identified as the funnel for a particular product or service, i.e., a product or service funnel. In the example shown in FIG. 6, conversion point 600 represents an actual purchase of product 655. Thus, the paths formed by the web pages are associated with product 655. For each web page, the probability value indicates the likelihood that a user of the web page will eventually purchase product 655 as a result of viewing information on product 655 displayed on the web page.

Once the web pages have been characterized with respect to the conversion point, at 760, for each web page in the funnel, the effectiveness in terms of product or service advertisement may be determined with respect to the corresponding conversion point based on a portion or all of the determined characteristics of the web page. The advertisement effectiveness for web pages indicates the degree of effectiveness a particular web page has in directing users of the web page, i.e., consumers, toward a conversion point for a product or service.

When implementing the method, the effectiveness for the web pages may be represented using a numeric scale system, with higher numbers indicating stronger effectiveness and lower numbers indicating weaker effectiveness.

Recall that as shown in FIG. 2, in practice, a network may include many different types of conversion points, each having a corresponding funnel formed by one or more paths. Thus, steps 720, 730, 740, 750, and 760 may be repeated multiple times for the many conversion points in order to construct a funnel for each existing conversion point.

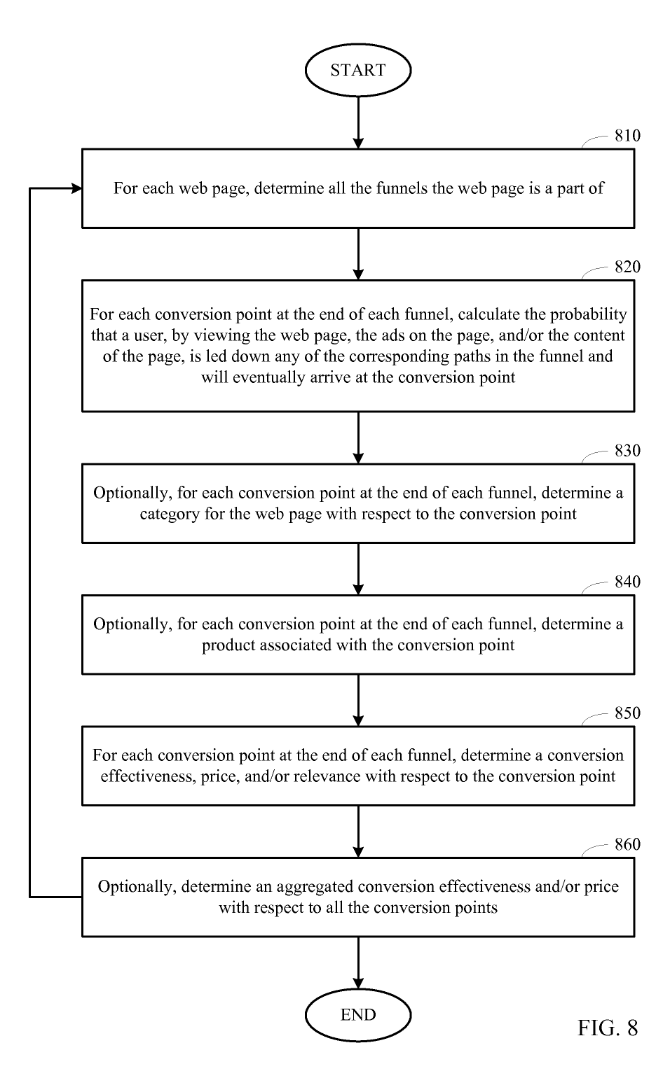

Not only is it possible for a web page to be a part of multiple paths leading to the same conversion point, it is also possible for a web page to be a part of multiple paths leading to different conversion points, as shown in FIG. 5. For such web pages, it may be necessary to characterize them with respect to each of the conversion points that the web pages are a part of the funnels for the conversion points, taking into consideration that these web pages may lead users to multiple conversion points. FIG. 8 is a method of characterizing a web page with respect to each of the conversion points that the web page is on at least one path leading to the conversion point.

At 810, for each web page, determine all the funnels that the web page is a part of. Recall that each individual funnel is constructed with respect to a conversion point, and at the bottom of each funnel is the conversion point. Thus, a web page is a part of a funnel if it is a part of or on any of the paths leading to the conversion point at the end of the funnel. As described in FIG. 7, for each conversion point, its funnel may be constructed by back tracing the paths leading to the conversion point, and the back tracing process is repeated for all the conversion points. Thus, if a particular web page is a part of two or more funnels, during the back tracing process for each of the conversion points associated with the funnels, the web page will be determined as a part of all those funnels. In FIG. 5, constructing the funnels for both conversion points 252 and 253 will result in web page 214 being a part of the funnel associated with conversion point 252 and also a part of the funnel associated with conversion point 253.

The process may be implemented as a computer software program. A data structure may be defined to represent a web page in such a way that there are appropriate data fields and/or data sub-structures included in the data structure to indicate all the paths the web page is on and the conversion points associated with the paths.

At 820, for each conversion point at the end of each funnel that the web page is a part of, calculate the probability that a user, by viewing the web page, is led down any of the paths in the funnel and will eventually arrive at the conversion point. The probability with respect to each different conversion point may be calculated in the similar manner as described in FIG. 7, step 730. The same process may be repeated with respect to each conversion point. In the example shown in FIG. 5, for web page 214, one probability value may be calculated with respect to conversion point 252, and another probability value may be calculated with respect to conversion point 253.

Optionally, a second type of aggregated value may be calculated for the web page based on the multiple probability values or scores with respect to the different conversion points, which represents a likelihood that a user may be led to any of the conversion points that the web page is a part of the funnel associated with the conversion point. The aggregated value for the web page may be some combination of the probability values associated with the individual conversion points. The manner in which these individual values are combined may further relate to similarities or differences between the conversion points. For example, as explained above, there are different types of conversion points, some may be more desirable or valuable than others. Often, to a business, i.e., sponsor, a product purchase type of conversion point may be more valuable than a lead providing type of conversion point. Thus, the value for the web page with respect to a more valuable conversion point may be given more weight than the value for the same web page with respect to a less valuable conversion point when the individual values are aggregated. In this case, the aggregated value for the web page may not be the sum of all the values with respect to the corresponding conversion points.

At 830, for each conversion point at the end of each funnel, optionally determine a category for the web page with respect to the conversion point. The categories with respect to each of the conversion points may be determined in the similar manner as described in FIG. 7, step 740. The same process may be repeated with respect to each conversion point. In the example shown in FIG. 5, for web page 214, one category may be determined with respect to conversion point 252, and another category may be determined with respect to conversion point 253.

At 840, optionally, for each conversion point at the end of each funnel, determine the product or service associated with the conversion point. There are different types of conversion points, and each conversion point is often associated with a particular product or service. When characterizing the web page with respect to the different conversion points, it may be optionally taken into consideration the product or service associated with each conversion point so that it may be determined how effective a web page is with respect to resulting in conversions for a particular product or service. Sometimes, it is possible that a web page may be very effective with respect to one product or service, while not so effective with respect to another.

In addition, user demographic information and other information may also be taken into consideration when charactering the web page with respect to the multiple conversion points, in a similar manner as described with reference to FIG. 7, step 750.

At 850, for each conversion point at the end of each funnel, determine the effectiveness in terms of product or service conversions with respect to the conversion point. Conversion efficiency may be determined, for example, based on cost per conversion and/or profit per conversion and/or yield per conversion for the product funnel. Again, this may be done in a manner similar to FIG. 7, step 760, and the same process may be repeated for each conversion point.

At 860, optionally, determine an aggregated conversion effectiveness with respect to all the conversion points. The aggregated conversion effectiveness with respect to all the conversion points may take into consideration the conversion effectiveness with respect to each individual conversion point. If a web page may potentially lead users to many different conversion points, the aggregated conversion effectiveness for the web page may be relatively higher than a web page that may potentially lead users to fewer different conversion points or only one conversion point.

Steps 810, 820, 830, 840, 850, and 860 may be repeated multiple times for all the web pages that lead users to different conversion points.

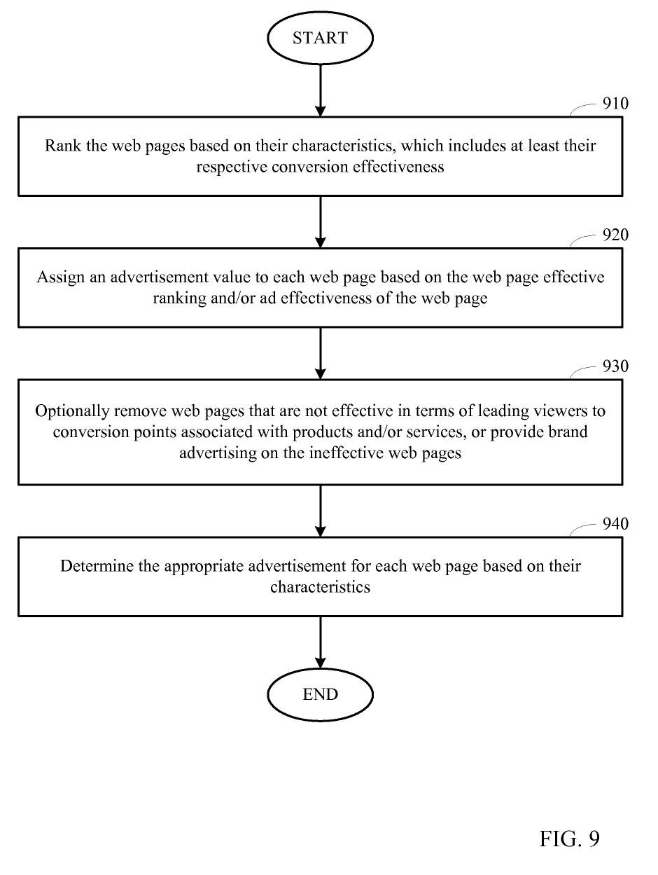

Once the web pages have been properly characterized with respect to individual or multiple conversion points, they may be analyzed. FIG. 9 illustrates a method of analyzing web pages based on their characteristics with respect to the corresponding conversion points in order to determine the appropriate advertisements for the web pages. There are different ways to analyze the web pages, depending on the purposes of analysis.

For example, at 910, the web pages may be ranked based on their characteristics, which includes at least their respective conversion effectiveness with respect to individual conversion point or multiple conversion points. Recall that conversion effectiveness may be represented using a numerical scale system. The web pages may be ranked accordingly. The ranking may be based on the aggregated effectiveness with respect to all the conversion points that the web pages may lead to, or based on the effectiveness with respect to a single conversion point. The ranking may be limited to a particular product only. The ranking may also be limited to effectiveness determined for a particular group of users belong to a specific demographic group or audience segment.

Based on the effectiveness ranking, at 920, an advertisement value may be assigned to each web page, which may indicate how valuable the web page is to a sponsor and/or a publisher. Several factors may affect the advertisement value of a web page. First, if a web page is highly effective in leading users to one or more conversion points, it would generally be more valuable to sponsors and/or publishers than a web page that is not so effective in leading users to one or more conversion points. Second, a particular web page may be highly effective in leading users to one or more conversion points with respect to one product, and yet not so effective with respect to other products. A second web page may be generally effective in leading users to one or more conversion points with respect to several products. In this case, the first web page may have a relatively lower aggregated effectiveness than the second web page, and yet, the first web page may be highly valuable to a sponsor of the one product for which the web page is particularly effective. Third, a web page may be particularly effective when it comes to users of a specific profile group or user segment, e.g., young people, perhaps because of its trendy design or content. In this case, if a sponsor's products target young people, the web page may be highly valuable to that sponsor, while at the same time, the web page may not be very valuable to a sponsor that have products targeting seniors. In short, different factors affect the advertisement value of a web page in different ways, and what is valuable to one sponsor may not be so valuable to another sponsor.

From a publisher's point view, generally speaking, the more effective a web page is in selling products, the more valuable the web page is, because the publisher may be able to obtain a higher fee from sponsors for advertising on such a web page. Thus, by analyzing the effectiveness of its web pages, the publisher may determine the appropriate fee for each of the web pages to be charged for displaying advertisements on the web pages.

Conversely, some web pages may not be effective at all in terms of resulting in conversions for the associated products and/or services. At 930, these ineffective web pages may be removed from the network. For example, if a particular web page has a very low aggregated effectiveness, and at the same time is not very effective with respect to any particular product, such a web page may be removed from the network and/or be replaced by another, more effective web page. Alternatively, instead of removing such a web page, the web page may be modified in some way, e.g., modified to provide general product awareness. Or, these ineffective web pages may be used for brand advertising, where the advertiser is aiming to show ad or product impressions rather than to get product conversions.

At 940, based on each web page's characteristics, the appropriate or suitable advertisement may be determined for the web page. The appropriateness may be in terms of the types of products or services to which the information presented on the web page relates. For example, if a web page has a high probability of leading its users to a conversion point associated with a particular product, then an advertisement which includes content relating to that type of product may be placed on this web page to further encourage users to traverse down the path toward the conversion point, or event to intentionally divert the user to another funnel for a similar competing product.

According to a specific embodiment, the determination of the advertisements to serve may be additionally based on the effectiveness of the advertisements themselves. That is, multiple advertisements having content relating to a product or service associated with the web page are likely to be identified. All of these may be shown in some rotation or, alternatively, only the most effective advertisements might be shown. So, for example, where multiple advertisements might be appropriate for a particular page, only the highest ranking advertisements in terms of effectiveness might be shown. According to one example implementation, this ranking may be done with respect to the click-through rates for the advertisements, i.e., the percentage of users viewing the advertisements that actually click on them.

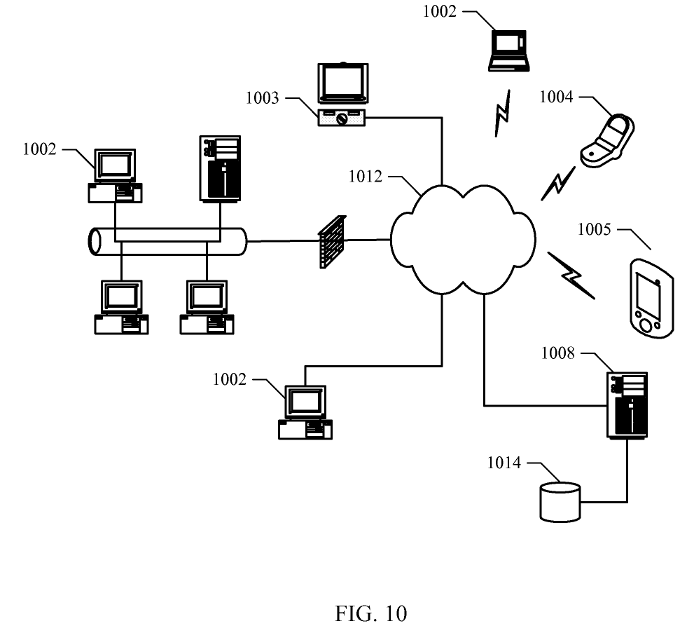

The methods shown in FIGS. 7, 8, and 9 may be implemented as computer software programs in a wide variety of computing contexts. FIG. 10 is a simplified diagram of an example of a network environment in which specific embodiments of the present invention may be implemented. The various aspects of the invention may be practiced in a wide variety of network environments (represented by network 1012) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations. All or a portion of the software program implementing various embodiments may be executed on the server 1008. Similarly, a website may be hosted on the server 1008 or by one of the computers 1002, 1003.

The session data associated with user online activities may be collected and stored in database(s) such as database 1014. These data may be used to back trace web pages leading to conversion points. Similarly, once the web pages and the conversion points have been identified, their relationships, i.e., topographic information, may be stored in the same or a different database. Characteristics associated with the web pages, such as probability values, products, advertising content, etc., may also be stored in the same or a different database.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method for determining the effectiveness of web pages, comprising:
for each of a plurality of conversion points corresponding to a particular product or service, determining a plurality of paths leading to the conversion point, wherein each of the plurality of paths leading to the conversion point includes a plurality of web pages connected by links; and
characterizing each web page with respect to each of selected ones of the plurality of conversion points which may be reached from the web page via at least one of the paths, wherein characterizing each web page includes determining a measure of effectiveness which represents a likelihood that viewing of the web page will lead to one or more of the selected conversion points.

2. The computer-implemented method, as recited in claim 1, wherein determining the plurality of paths leading to each of the plurality of conversion points and characterizing each web page with respect to each of the selected ones of the plurality of conversion points are based on web session data representing a population of users interacting with at least one selected from the group consisting of the web pages, contents of the web pages, and ads displayed in the web pages.

3. The computer-implemented method, as recited in claim 1, wherein the measure of effectiveness for each web page with respect to each of the selected ones of the plurality of conversion points is determined based on a probability that viewing of the page will lead to one or more of the selected conversion points.

4. The computer-implemented method, as recited in claim 1, wherein characterizing each web page with respect to each of the selected ones of the plurality of conversion points further includes
determining a category for the web page based on its position in relation to one or more of the selected conversion points which may be reached from the web page via at least one of the paths; and
determining a purpose with respect to one or more of the selected conversion points which may be reached from the web page via at least one of the paths.

5. The computer-implemented method, as recited in claim 1, wherein characterizing each web page with respect to each of the selected ones of the plurality of conversion points is based on data associated with a selected group of users sharing similar profiles.

6. The computer-implemented method, as recited in claim 1, further comprising:
determining content of advertisements placed on each web page based on the product or service corresponding to one or more of the selected ones of the plurality of conversion points which may be reached from the web page via at least one of the paths;
identifying a plurality of advertisements for each web page with reference to the content;
ranking the plurality of advertisements associated with each web page with reference to a measure of advertising effectiveness associated with each; and
presenting selected ones of the plurality of advertisements on the associated web pages with reference to the ranking.

7. The computer-implemented method, as recited in claim 1, further comprising:
modifying or removing web pages having low measures of effectiveness.

8. A computer-implemented method for presenting advertisements on web pages, wherein links among the web pages define a plurality of paths leading to a plurality of conversion points, and each conversion point corresponding to a particular product or service, the method comprising presenting the advertisements on the web pages, each advertisement having been selected for presentation on a particular one of the web pages with reference to a measure of effectiveness associated with particular web page, the measure of effectiveness representing a likelihood that viewing of the particular web page will lead to one or more of the conversion points.

9. The computer-implemented method, as recited in claim 8, wherein the measure of effectiveness for each web page with respect to each of selected ones of the plurality of conversion points is determined based on a probability that viewing of the page will lead to one or more of the selected conversion points.

10. The computer-implemented method, as recited in claim 8, further comprising:
determining content of advertisements placed on each web page based on the product or service corresponding to one or more of selected ones of the plurality of conversion points which may be reached from the web page via at least one of the paths.

11. The computer implemented method of claim 10, further comprising:
identifying a plurality of advertisements for each web page with reference to the content;
ranking the plurality of advertisements associated with each web page with reference to a measure of advertising effectiveness associated with each; and
presenting selected ones of the plurality of advertisements on the associated web pages with reference to the ranking.

12. A system for determining the effectiveness of web pages, comprising at least one computing device configured to:
for each of a plurality of conversion points corresponding to a particular product or service, determine a plurality of paths leading to the conversion point, wherein each of the plurality of paths leading to the conversion point includes a plurality of web pages connected by links; and
characterize each web page with respect to each of selected ones of the plurality of conversion points which may be reached from the web page via at least one of the paths, wherein to characterize each web page includes to determine a measure of effectiveness which represents a likelihood that viewing of the web page will lead to one or more of the selected conversion points.

13. The system, as recited in claim 12, wherein to determine the plurality of paths leading to each of the plurality of conversion points and to characterize each web page with respect to each of the selected ones of the plurality of conversion points are based on web session data representing a population of users interacting with the web pages.

14. The system, as recited in claim 12, wherein the measure of effectiveness for each web page with respect to each of the selected ones of the plurality of conversion points is determined based on a probability that viewing of the page will lead to one or more of the selected conversion points.

15. The system, as recited in claim 12, wherein to characterize each web page with respect to each of the selected ones of the plurality of conversion points further includes
to determine a category for the web page based on its position in relation to one or more of the selected conversion points which may be reached from the web page via at least one of the paths; and
to determine a purpose with respect to one or more of the selected conversion points which may be reached from the web page via at least one of the paths.

16. The system, as recited in claim 12, wherein the at least one computing device is further configured to:
determine content of advertisements placed on each web page based on the product or service corresponding to one or more of the selected ones of the plurality of conversion points which may be reached from the web page via at least one of the paths;
identify a plurality of advertisements for each web page with reference to the content;
rank the plurality of advertisements associated with each web page with reference to a measure of advertising effectiveness associated with each; and
present selected ones of the plurality of advertisements on the associated web pages with reference to the ranking.

17. The system, as recited in claim 12, wherein the at least one computing device is further configured to:
modify or remove web pages having low measures of effectiveness.

18. A computer program product for online advertisement comprising a computer-readable medium having a plurality of computer program instructions stored therein, which are operable to cause at least one computing device to:
for each of a plurality of conversion points corresponding to a particular product or service, determine a plurality of paths leading to the conversion point, wherein each of the plurality of paths leading to the conversion point includes a plurality of web pages connected by links; and
characterize each web page with respect to each of selected ones of the plurality of conversion points which may be reached from the web page via at least one of the paths, wherein characterizing each web page includes determining a measure of effectiveness which represents a likelihood that viewing of the web page will lead to one or more of the selected conversion points.

19. The computer program product, as recited in claim 18, wherein to determine the plurality of paths leading to each of the plurality of conversion points and to characterize each web page with respect to each of the selected ones of the plurality of conversion points are based on web session data representing a population of users interacting with the web pages.

20. The computer program product, as recited in claim 18, wherein the measure of effectiveness for each web page with respect to each of the selected ones of the plurality of conversion points is determined based on a probability that viewing of the page will lead to one or more of the selected conversion points.

21. The computer program product, as recited in claim 18, wherein to characterize each web page with respect to each of the selected ones of the plurality of conversion points further includes to determine a category for the web page based on its position in relation to one or more of the selected conversion points which may be reached from the web page via at least one of the paths.

22. The computer program product, as recited in claim 18, wherein to characterize each web page with respect to each of the selected ones of the plurality of conversion points further includes to determine a purpose with respect to one or more of the selected conversion points which may be reached from the web page via at least one of the paths.

23. The computer program product, as recited in claim 18, wherein the plurality of computer program instructions are further operable to cause the at least one computing device to:
determine content of advertisements placed on each web page based on the product or service corresponding to one or more of the selected ones of the plurality of conversion points which may be reached from the web page via at least one of the paths.

24. The computer program product, as recited in claim 23, wherein the plurality of computer program instructions are further operable to cause the at least one computing device to:
identify a plurality of advertisements for each web page with reference to the content;
rank the plurality of advertisements associated with each web page with reference to a measure of advertising effectiveness associated with each; and
present selected ones of the plurality of advertisements on the associated web pages with reference to the ranking.

25. The computer program product, as recited in claim 18, wherein the plurality of computer program instructions are further operable to cause the at least one computing device to:
modify or remove web pages having low measures of effectiveness.
